(19) United States
(12) Patent Application Publication
(10) Pub. No.: US 2007/0165354 A1
(43) Pub. Date: Jul. 19, 2007

(54) Microscale air-cleaning device

(76) Inventors: Chih-Cheng Wu, Taipei (TW); Whei-May Grace Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/333,447

(22) Filed: Jan. 18, 2006

(51) Int. Cl. B03C 3/41

(52) U.S. Cl. 361/226; 96/97; 95/57

(57) ABSTRACT

A microscale air-cleaning device is provided that includes an integrated circuit chip, carbon nanotubes, and a power supply. The carbon nanotubes are assembled on the integrated circuit chip and are connected with the integrated circuit chip. The power supply is provided for powering the integrated circuit chip.

### BACKGROUND

1. Field of Invention

The present invention relates to an air-cleaning device. More particularly, the present invention relates to a microscale air-cleaning device.

2. Description of Related Art

With industrial and commercial heavily development, population density of cities has been increasing day-by-day and air pollution has consequently been worsening. In recent years, air pollution caused by emissions from motor vehicles, power plants, and factories has become a chronic hazard to the public health. Therefore, air quality has become more and more emphasized by the public.

Air pollution can be classified as indoor and outdoor air pollution. The sources of indoor air pollution are such as cigarette smoking, spaying aerosols, and the emissions from indoor building materials that can easily become airborne. The sources of outdoor air pollution are vehicle exhaust, factory emissions, waste incineration and etc.

There are many ways to improve the air quality, that include restricting the sources of vehicle exhaust and factory emissions by the laws, using air-cleaning devices to eliminate air pollutants and pathogens, and wearing face masks to filter out air pollutants.

Personal air-cleaning devices work well to purify the surrounding air of user. However, traditional personal air-cleaning devices are too bulky and energy-consuming to satisfy the needs of users.

Therefore, it is necessary to provide a microscale and energy-saving air-cleaning device to solve the problems described above.

### SUMMARY

It is therefore an aspect of the present invention is to provide microscale air-cleaning device which is thin, lightweight and convenient.

Another aspect of the present invention is to provide a microscale air-cleaning device which consumes low electrical power and saves energy.

In accordance with the foregoing aspects, one embodiment of the present invention provides a microscale air-cleaning device that comprises an integrated circuit chip, at least one carbon nanotube and a power supply. The carbon nanotube is installed on the integrated circuit chip and is electrically connected to it. The power supply is used to generate electric power and is electrically connected to the integrated circuit chip. The power supply is preferably a small size mercury battery or fuel battery.

When the power supply is turned on, electrical current runs through the integrated circuit chip to provide the carbon nanotube with suitable electrical power. At that time, the carbon nanotube discharges electrons from the tip of the carbon nanotube to excite the molecules in the air to the extent that they form negative air ions. Then, the negative air ions combine with and negatively charge the air pollutants, such as suspended particles, bacteria, and viruses, and thus cause that the air pollutants have electrical negative charges.

The users's clothes will also carry negatively charges with the aid of the microscale air-cleaning device. Therefore, the negatively charged air pollutants are repelled by the negatively charged clothes surfaces and surrounding air of users, and then the surrounding air is purified. Moreover, the charged air pollutants are enhanced to settle to the ground and the surface of objects, and further, that cleans the air.

According to the demands, the microscale air-cleaning device can be installed on personal articles to achieve lightweight, convenience and beauty. These personal articles are preferably buttons, necklaces, watches, cell-phones, safety pins, hairpins or other decorative accessories.

Therefore, the microscale air-cleaning device can reduce air pollutants by a low energy consuming mechanism. By utilizing carbon nanotubes, the microscale air-cleaning device offers smallness, lightweight, and portability. Moreover, combining the microscale air-cleaning device with personal articles can achieve convenience and beauty.

### BRIEF DESCRIPTION OF THE DRAWINGS

The invention can be more fully understood by reading the following detailed description of the preferred embodiments, with reference made to the accompanying drawings as follows:

FIG. 1 is a diagram of the structure of a carbon nanotube.

FIG. 2 is a diagram of a microscale air-cleaning device according to a preferred embodiment of the invention.

FIG. 3 is a diagram of combining the microscale air-cleaning device with a personal article according to a preferred embodiment of the invention.

### DETAILED DESCRIPTION OF THE PREFERRED EMBODIMENTS

The microscale air-cleaning device of the present invention can solve the high energy consumption problem and reduce bulky size for traditional personal air-cleaning devices. The microscale air-cleaning device utilizes carbon nanotubes as the discharge electrodes to significantly reduce energy consumption and the size of personal air-cleaning device.

Reference is made to FIG. 1, which is a diagram of the structure of a carbon nanotube. FIG. 1 shows that the structure of carbon nanotube is similar to a sheet of carbon atoms in hexagonal arrangement rolled into a tubular shape. According to different manufacturing technologies, carbon nanotubes can have different diameters, lengths, number of walls, and structures. Generally speaking, the diameter range of the carbon nanotubes is preferably about 0.4 nm to a few of nanometers. The length of the carbon nanotube is preferably about a few hundred nanometers to a few thousand micrometers.

Generally speaking, carbon nanotubes can be grown as a single-walled carbon nanotube or a multi-walled carbon nanotube. Among them, the diameter of a single-walled carbon nanotube is preferably about 0.4 nm to a few nanometers. The diameter of multi-walled carbon nanotubes is preferably about a few nanometers. Because carbon nanotubes are nanoscale of diameter, microscale of length, high strength, highly thermally conductive, highly electrically conductive, and so forth, carbon nanotubes are considered to be a good material in the field of nanometer-scaled products.

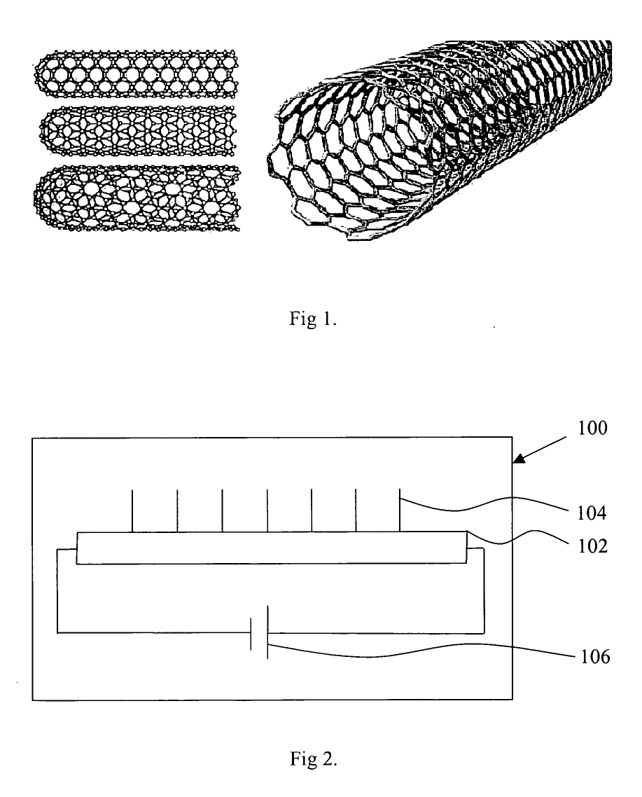

Reference is made to FIG. 2, which is a diagram of a microscale air-cleaning device according to a preferred embodiment of the invention. The microscale air-cleaning device 100 comprises an integrated circuit chip 102, carbon nanotubes 104, and a small size power supply 106. The operating voltage of the microscale air-cleaning device 100 is preferably about 0.5 eV to 110 volts. The carbon nanotubes 104 are installed on the integrated circuit chip 102 and are electrically connected with the integrated circuit chip 102. The small size power supply 106 is used to generate electrical power and is electrically connected to the integrated circuit chip 102. The small size power supply 106 is preferably a mercury battery or fuel battery.

When the small size power supply 106 is turned on, electrical current passes through the integrated circuit chip 102 and provides the carbon nanotube 104 with suitable electrical power. At the same time, the carbon nanotube 104 discharges electrons from its tip and excites the molecules in the surrounding air of the carbon nanotube. The molecules are ionized by such electrons discharging with high energy to form negative ions in the air. These negatively charged molecules or molecular clusters in the air are called negative air ions. In contrast, positively charged molecules or molecular clusters in the air are called positive air ions. According to a preferred embodiment of the invention, the air ions are preferably negative air ions.

According to the demands, the microscale air-cleaning device can be installed on personal articles to achieve lightweight, convenience, and beauty.

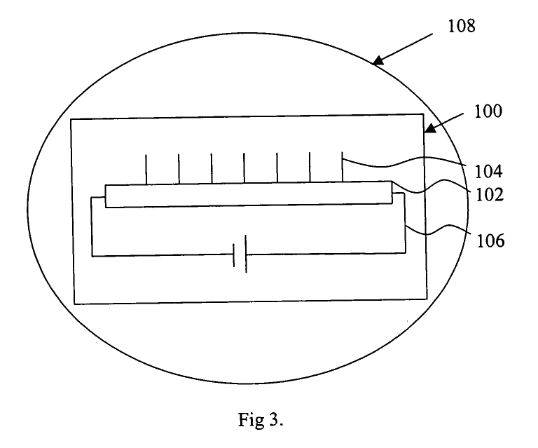

Reference is made to FIG. 3, which is a diagram of a preferred embodiment of combining the microscale air-cleaning device with a personal article. In FIG. 3, the microscale air-cleaning device 100 is installed on a personal article 108 to achieve lightweight, convenience, and beauty. The personal article 108 is preferably a button, necklace, watch, cell-phone, safety pin, hairpin or other decorative article.

When the small size power supply 106 is turned on, electrical current runs through the integrated circuit chip 102 to the tips of the carbon nanotubes 104 to discharge electrons from the tips and form negative air ions in the air. The negative air ions collide with the air pollutants, such as suspended particles, bacteria, and viruses, and then the air pollutants are negatively charged. Human bodies carrying the microscale air-cleaning devices cause the surrounding air and the clothing surfaces negatively charged, and thus repel the negatively charged air pollutants. Therefore, the negatively charged air pollutants are kept away from the microscale air-cleaning device and the surrounding air is purified. Moreover, electrically charged air pollutants are enhanced to settle to the ground and the other surfaces, thus further purifying the air.

Accordingly, the present invention has the following advantages.

(1) The microscale air-cleaning device is thin, lightweight and easy to carry.

(2) The microscale air-cleaning device is energy-saving.

(3) The microscale air-cleaning device can combine with personal articles to achieve convenience and beauty.

The preferred embodiments of the present invention described above should not be regarded as limitations to the present invention. It will be apparent to those skilled in the art that various modifications and variations can be made to the present invention without departing from the scope or spirit of the invention. The scope of the present invention is as defined in the appended claims.

What is claimed is:

1. A microscale air-cleaning device, which comprises:
an integrated circuit chip;
at least one carbon nanotube, which is electrically connected to the integrated circuit chip, wherein the carbon nanotube comprises a plurality of discharge ends to generate a plurality of air ions; and
a power supply, which is electrically connected to the integrated circuit chip to provide a voltage which can make the carbon nanotube on the integrated circuit chip discharge.

2. The microscale air-cleaning device of claim 1, wherein the diameter of the carbon nanotube is about 0.4 nm to a few nanometers.

3. The microscale air-cleaning device of claim 1, wherein the length of the carbon nanotube is about a few hundred nanometers to a few thousand micrometers.

4. The microscale air-cleaning device of claim 1, wherein the carbon nanotube is a single-walled carbon nanotube or multi-walled carbon nanotube.

5. The microscale air-cleaning device of claim 4, wherein the diameter of the single-walled carbon nanotube is about 0.4 nm to a few nanometers.

6. The microscale air-cleaning device of claim 4, wherein the diameter of the multi-walled carbon nanotube is about a few nanometers.

7. The microscale air-cleaning device of claim 1, which further comprises an article, the microscale air-cleaning device can fix on the article to increase its beauty.

8. The microscale air-cleaning device of claim 1, wherein an operating voltage is about 0.5 eV to 110 volts.

9. A microscale air-cleaning device, which comprises:
an integrated circuit chip; and
at least one carbon nanotube, which is electrically connected to the integrated circuit chip, wherein the carbon nanotube comprises a plurality of discharge ends to generate a plurality of air ions.

10. The microscale air-cleaning device of claim 9, which further comprising a power supply, which is electrically connected to the integrated circuit chip.

11. The microscale air-cleaning device of claim 9, wherein the diameter of the carbon nanotube is about 0.4 nm to a few nanometers.

12. The microscale air-cleaning device of claim 9, wherein the length of the carbon nanotube is about a few hundred nanometers to a few thousand micrometers.

13. The microscale air-cleaning device of claim 9, wherein the carbon nanotube is single-walled carbon nanotube or multi-walled carbon nanotube.

14. The microscale air-cleaning device of claim 13, wherein the diameter of the single-walled carbon nanotube is about 0.4 nm to a few nanometers and the diameter of the multi-walled carbon nanotube is about a few nanometers.

15. The microscale air-cleaning device of claim 9, which further comprises an article, the microscale air-cleaning device can fix on the article to increase its beauty.

16. The microscale air-cleaning device of claim 9, wherein an operating voltage is about 0.5 eV to 110 volts.

17. A method of reducing air pollutants, which comprises:
providing a power supply to provide a voltage;
providing an integrated circuit chip, which is electrically connected to the power supply; and
installing at least one carbon nanotube on the integrated chip, wherein the carbon nanotube is electrically connected to the integrated chip to generated a plurality of air ions.

18. The method of claim 17, wherein the voltage is about 0.5 eV to 110 volts.

19. The method of claim 17, wherein the diameter of the carbon nanotube is about 0.4 nm to a few nanometers.

20. The method of claim 17, wherein the length of the carbon nanotube is about a few hundred nanometers to a few thousand micrometers.
